(19) United States
(12) Patent Application Publication
(10) Pub. No.: US 2006/0215399 A1
(43) Pub. Date: Sep. 28, 2006

(54) Lighting apparatus of elevator

(75) Inventor: Masahiko Endo, Fuchu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Elevator Kabushiki Kaisha, Shinagawa-ku (JP)

(21) Appl. No.: 11/377,378

(22) Filed: Mar. 17, 2006

Related U.S. Application Data
(63) Continuation of application No. PCT/JP04/16279, filed on Oct. 27, 2004.

(30) Foreign Application Priority Data
Oct. 31, 2003 (JP) 2003-373539

(51) Int. Cl. F21V 9/00

(52) U.S. Cl. 362/231

(57) ABSTRACT

A lighting apparatus of an elevator has a light source element for lighting in the cage, which is provided on the ceiling of an elevator. The light source element composes combination of light sources including at least one first light source to emit a first lighting color, and at least one second light source to emit a second lighting color different from the first lighting color. The light sources with different lighting colors are simultaneously used, providing various color tones.

### CROSS REFERENCE TO RELATED APPLICATIONS

This is a Continuation Application of PCT Application No. PCT/JP2004/016279, filed Oct. 27, 2004, which was published under PCT Article 21(2) in English.

This application is based upon and claims the benefit of priority from prior Japanese Patent Application No. 2003-373539, filed Oct. 31, 2003, the entire contents of which are incorporated herein by reference.

### BACKGROUND OF THE INVENTION

1. Field of the Invention

The present invention relates to a lighting apparatus for lighting a room of a cage of an elevator.

2. Description of the Related Art

A cage of an elevator has a ceiling at the top. A lighting box is fixed to the lower side of the ceiling. The lighting box has a large opening at the bottom. The opening is provided with a light-diffuser panel with light transmittivity made of synthetic resign, for example.

A plurality of fluorescent lamps (hot-cathode tubes) is provided on the lower side of the ceiling as a light source element. When these fluorescent lamps are lit, the light is diffused in the cage through the light-diffuser panel, and the inside of cage is lit up.

The lighting color of the fluorescent lamp used as a light source element for lighting in the cage is selected as one standard color from several colors such as white and daylight white. The interior and decoration of the cage are designed to meet the selected standard color fluorescent lamp.

### BRIEF SUMMARY OF THE INVENTION

It is rare that the inside of a cage of an elevator is lit by natural light. The design and atmosphere of a cage depends much upon the effect of lighting in a cage. If one of the lighting colors such as white and daylight white, for a light source element is selected as a light in a cage, the tone in the cage becomes uniform, and it is difficult to create design and atmosphere to meet the location where an elevator is installed.

The present invention provides a lighting apparatus of an elevator, which can change the lighting color tone in the cage of an elevator and create desired design and atmosphere according to the location where an elevator is installed.

A lighting apparatus of an elevator according to the present invention has a light source element provided on the ceiling of the cage as a light in the cage. The light source element comprises combination of a plurality of light sources including at least one first light source which emits a first lighting color, and at least one second light source which emits a second lighting color different from the first lighting color.

A cold-cathode fluorescent lamp or at least one of elements such, as a light-emitting diode and an organic electro luminescence, is used as a light source. The light source is provided with regularity on the ceiling of a cage. In this case, adjacent light sources have different lighting colors.

### BRIEF DESCRIPTION OF THE SEVERAL VIEWS OF THE DRAWING

FIG. 1 is showing a schematic cross section of a cage along the vertical direction of an elevator having a lighting apparatus of a first embodiment according to the present invention.

FIG. 2 is a looked-up plan view of the ceiling of the cage shown in FIG. 1.

FIG. 3 is a looked-up plan view of the ceiling of a cage of an elevator having a lighting apparatus of a second embodiment according to the present invention.

FIG. 4 is a looked-up plan view of the ceiling of a cage of an elevator having a lighting apparatus of a third embodiment according to the present invention.

FIG. 5 is a looked-up plan view of the ceiling of a cage of an elevator having a lighting apparatus of a fourth embodiment according to the present invention.

FIG. 6 is a schematic cross section of a cage along the vertical direction of an elevator having a lighting apparatus of a fifth embodiment according to the present invention.

### DETAILED DESCRIPTION OF THE INVENTION

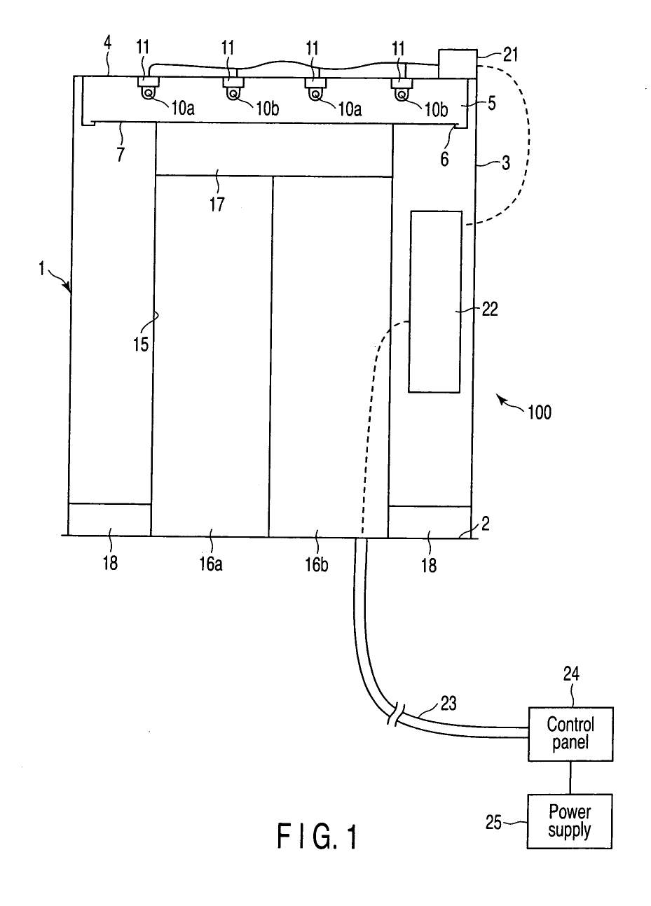

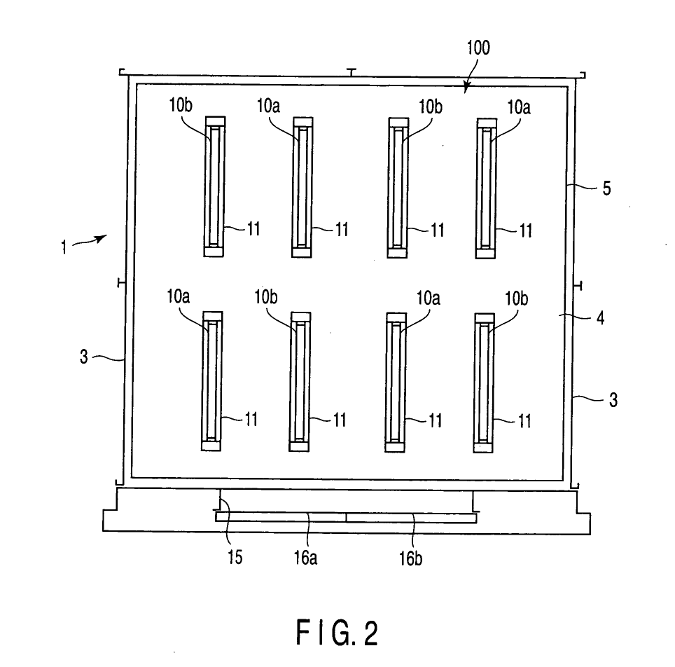

Explanation will be given on a fist embodiment according to the present invention with reference to FIG. 1 and FIG. 2.

FIG. 1 shows the configuration of a cage 1 of an elevator. The cage 1 has a floor 2, side plates 3 surrounding the upper four sides of the floor 2, and a ceiling 4 provided at the upper end of the side plates 3.

A lighting box 5 is provided in the lower side of the ceiling 4, and has a large opening 6. The opening 6 is provided with a light-diffuser panel 7 made of synthetic resign with light transmittivity. In the lower side of the ceiling 4, linear tube light sources 10a and 10b are arranged with regularity in a row through socket bases 11. The light emitted from the light sources 10a and 10b passes through the light-diffuser panel 7 and diffuses in the cage 1, and lights up the inside of the cage 1.

A lighting apparatus 100 includes light sources 10a and 10b, socket bases 11, a connector 21, an operation panel 22, a tail cord 23, a control panel 24, and an external commercial power supply 25. The external power supply 25 may be either the power of voltage available at the actual location, or the locally available power adjusted by a transformer. The external power supply 25 is connected to the control panel 24. The control panel 24 is connected to the operation panel 22 in the cage 1 through the tail cord 23.

The operation panel 22 is provided with a switch to turn on/off the external power supply 25. The operation panel 22 is connected to the connector 21 provided on the ceiling 4 of the outside of the cage 1. The connector 21 is connected parallel to each of the socket bases 11 in the lighting box 5. Each socket base 11 contains an inverter including a stabilizer and a transformer.

The cage 1 has a doorway 15 at the front. The doorway 15 has doors 16a and 16b to close the doorway 15. The upper sides of the doors 16a and 16b are covered by a curtain plate. The lower ends of the side plates 3 are provided with a truss plank 18.

The light sources 10a and 10b are disposed just like being equally arranged in the lengthwise and crosswise directions on the lower surface of the ceiling 4 as shown in FIG. 2. These light sources 10a and 10b are cold-cathode fluorescent lamps. The first light source 10a emits a first lighting color. The second light source 10b emits a second lighting color different from the first lighting color adjacent to the first light source 10a. As the first and second lighting colors, the colors that are created from three primary colors of light, red, blue and green may be used, in addition to white, daylight white, daylight and electric lamp colors.

Taking one example of combining the lighting colors, several light sources are white color, and the remaining light sources are daylight color. For example, among the eight light sources shown in FIG. 2, the first four light sources 10a are white, the remaining four second light sources 10b are daylight white. The first white light sources 10a and second daylight white light sources 10b are alternately arranged in a row in the lengthwise and crosswise directions.

As the lighting colors of the light sources 10a and 10b are different, compared with using a light source with one lighting color, the inside of the cage 1 is lit up in the unique tone of mixing several colors. The design and atmosphere in the cage 1 can be set to meet at the location where an elevator is installed.

Combination of the lighting colors of the light sources 10a and 10b is not limited to the above example. Various combinations are possible. For example, in FIG. 2, the left half light sources are white and the right half light sources are daylight white, the upper half light sources are white and the lower half light sources are daylight white, or two left and right light sources are white and the four middle light sources are daylight white. It is also possible to change the brightness in the cage 1 by changing the number of lighting lamps of the light sources 10a and 10b by the external control panel 24 according to the weather or the lightness in the outside.

As to the lighting colors of the light sources to be used, combination is not limited to white and daylight white. It is possible to combine light sources with various lighting colors including blue, red and green. This realizes fantastic illumination in the cage 1.

A cold-cathode fluorescent lamp used as the light sources 10a and 10b has a discharge cell with light transmittivity with the diameter of 1-6 mm, a pair of cold cathodes sealed at both ends of the discharge cell, a fluorescent substance applied to the inside of the discharge cell, and a discharge medium sealed in the discharge cell. The lamp is lit without heating the cathode, and the lamp life is not influenced by the number of times of turning on and off the lamp. The lamp has the characteristic that the life is determined only by the element caused by the lighting hours. The cold-cathode fluorescent lamp has another characteristic. The lamp is lit immediately after supplied with a voltage, and has no time delay up to lighting.

The light sources 10a and 10b employ the above-mentioned cold-cathode fluorescent lamp. A plurality of light sources with different lighting colors is provided on the ceiling 4. The cold-cathode fluorescent lamp has is small in the tube diameter, and less in the calorific value. Thus, the light sources 10a and 10b can be closely disposed on the ceiling 4. This permits lighting all areas of the light-diffuser panel 7 without unevenness when the lamp is lit, and lighting up the inside of the cage 1 evenly. Further, as the tube diameter of the cold-cathode fluorescent lamp used as the light sources 10a and 10b, the lighting box 5 can be made thin. The cage 1 can have a high ceiling and large inside space.

A cold-cathode fluorescent lamp has very long life compared with an ordinary fluorescent lamp. The lamp replacement period is long, and the maintenance is easy. A cold-cathode fluorescent lamp is lit without irregular flickers immediately after turned on unlike an ordinary fluorescent lamp. This permits smooth light up in the cage 1 immediately after turned on. Even if the light sources 10a and 10b are switched on the way of operation, the user will not feel incongruity.

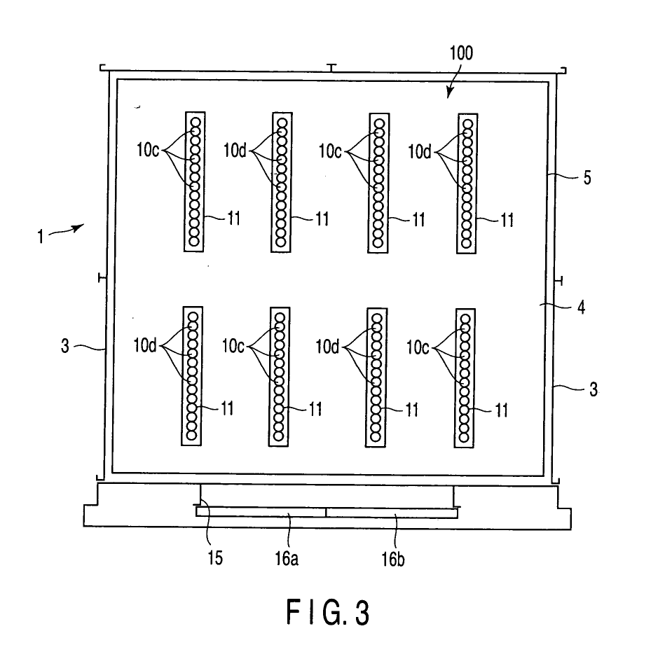

Now, description will be given on a lighting apparatus 100 of a second embodiment according to the present invention with reference to FIG. 3. The same reference numerals will be given to the components having the same functions as those of the lighting apparatus 100 of the first embodiment, and a detailed explanation will be omitted. The lighting apparatus 100 provided on the ceiling of the elevator shown in FIG. 3 has LEDs (Light-Emitting Diode) 10c as a first light source, and LEDs (Light-Emitting Diode) 10d as a second light source. In this embodiment, the LEDs 10c and 10d are closely arranged in a row and fixed to the socket bases 11. The LEDs 10c and 10d are provided by the number enough to satisfy the brightness necessary to light in the cage 1. Many lighting color are prepared as in the first embodiment. The LEDs 10c and 10d with different lighting colors can be used in the adjacent socket bases 11. The LEDs with different lighting colors can be used in the same socket base 11. The LEDs can also be arranged like a panel in addition to fixing like a unit in the socket bases 11 arranged in a row, as shown in FIG. 3.

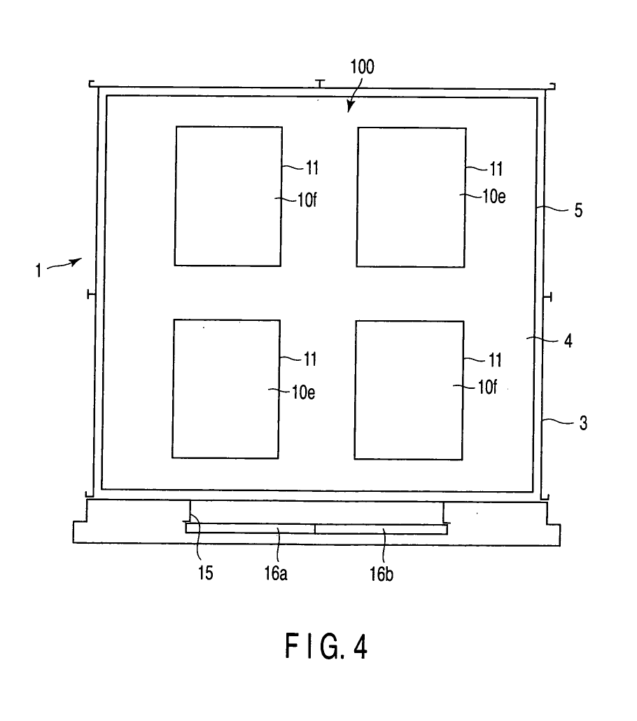

Next, description will be given on a lighting apparatus 100 of a third embodiment according to the invention with reference to FIG. 4. The same reference numerals will be given to the components having the same functions as those of the lighting apparatus 100 of the second embodiment, and a detailed explanation will be omitted. The lighting apparatus 100 provided on the ceiling of the elevator shown in FIG. 4 has organic ELs (Electro luminescence) 10e and 10f as first and second light sources. The organic ELs 10e and 10f formed like a panel may be a monochrome panel or a color panel capable of displaying several colors. The organic ELs 10e and 10f have the light-emitting areas enough to satisfy the brightness necessary to light in the cage 1. The organic ELs 10e and 10f may not only emit monotone light as a light source, but also project spacious sceneries such as the sky, fantastic landscapes and designs, or images and videos such as advertisements.

In the second and third embodiments, the light sources are LEDs 10c/10d and organic ELs 10e/10f, and the socket bases 11 contain no inverters. The LEDs 10c and 10d may be disposed as light sources in the socket bases 11. The organic ELs 10e and 10f may be disposed in the socket bases 11. The LEDs 10c/10d and organic ELs 10e/10f may be combined appropriately and disposed in the socket bases 11. A conventional common driving control unit is used as a means to control the lighting of the LEDs 10c/10d and organic ELs 10e/10f.

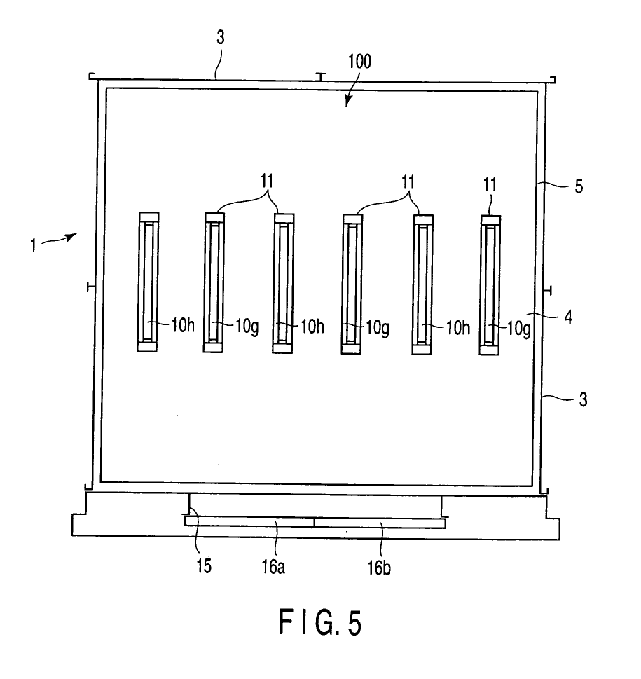

Next, description will be given on a lighting apparatus 100 of a fourth embodiment according to the invention with reference to FIG. 5. The same reference numerals will be given to the components having the same functions as those of the lighting apparatus 100 of the first embodiment, and a detailed explanation will be omitted. In the lighting apparatus 100 shown in FIG. 5, cold-cathode fluorescent lamps 10g and 10h used as first and second light sources are disposed three each with equal intervals on the left and right sides of the center of the cage 1 facing the doorway 15.

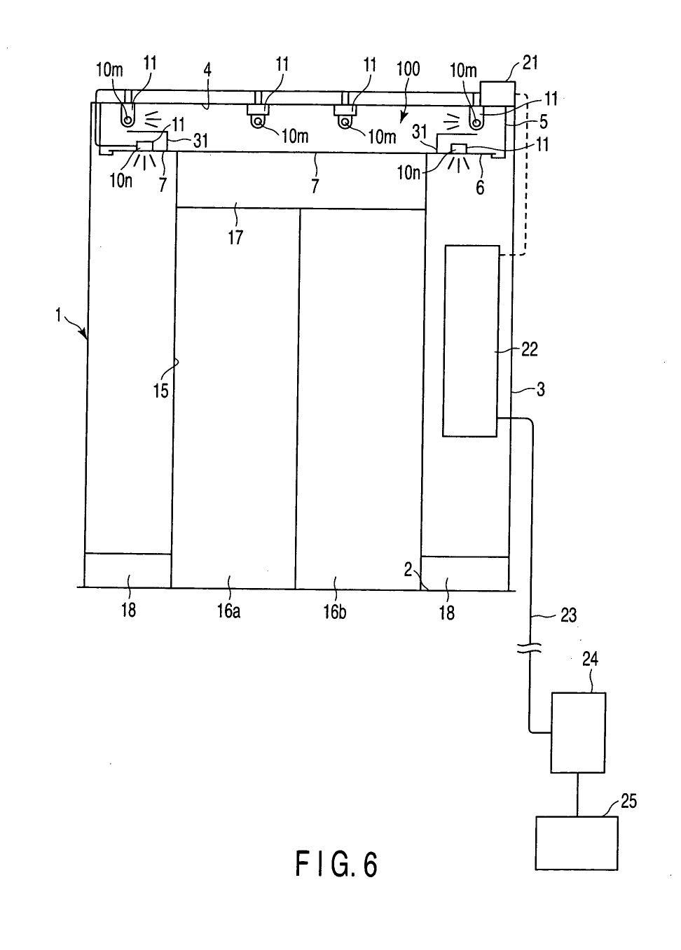

Next, description will be given on a lighting apparatus 100 of a fifth embodiment according to the invention with reference to FIG. 6. The same reference numerals will be given to the components having the same functions as those of the lighting apparatus 100 of the first embodiment, and a detailed explanation will be omitted. The lighting apparatus 100 shown in FIG. 6 has first light sources 10m with a first lighting color, and second light sources 10n with a second lighting color different from the first lighting color.

The first light sources 10m are provided inside the lighting box 5 on the ceiling. The second light sources 10n are provided inside the light-diffuser panel 7. The second light sources 10n are arranged along the upper corners of the cage 1, and surrounded by a partition 31 extending between the light-diffuser panel 7 and the first light source 10m. The light emitted from the first light sources 10m passes through the inner area of the light-diffuser panel 7 surrounded by the partition 31, and lights up the inside of the cage 1. The light from the second light sources 10n passes through the outer area of the light-diffuser panel 7 surrounded by the partition 31, and lights up the inside of the cage 1.

A concrete example of the first lighting color is daylight. A concrete example of the second lighting color is white. When a cold-cathode tube is used as a light source, the lighting color is changed by the fluorescent substance applied to the inside of the glass tube.

The first light source 10m may be a cold-cathode tube. The second light source 10n may be an LED. It is permitted to combine the cold-cathode tube, LED and organic EL.

According to the present invention, a plurality of light sources with different colors is provided, various color tones are available, and the lighting color in the cage can be set to the tone meeting at the location where an elevator is installed. Therefore, the design and atmosphere desired by the customer can be created.

The lighting apparatus according to the present invention is available for an artificial lighting in a closed space difficult to lead in light from the outside.

What is claimed is:

1. A lighting apparatus of an elevator comprising:
a cage of an elevator; and
a light source element for lighting in the cage, which is provided on the ceiling of an elevator;
wherein the light source element comprises combination of plurality of light sources including at least one first light source to emit a first lighting color, and at least one second light source to emit a second lighting color different from the first lighting color.

2. The lighting apparatus of an elevator according to claim 1, wherein the light sources are cold-cathode fluorescent lamps.

3. The lighting apparatus of an elevator according to claim 1, wherein the light sources are at least one of a light-emitting diode and an organic electroluminescence.

4. The lighting apparatus of an elevator according to claim 1, wherein the light sources are arranged with regularity on the ceiling of the cage.

5. The lighting apparatus of an elevator according to claim 4, wherein the light sources arranged with regularity on the ceiling of the cage are in the state that the light sources with different lighting colors are adjoined.

6. The lighting apparatus of an elevator according to claim 2, wherein the light sources are arranged with regularity on the ceiling of the cage.

7. The lighting apparatus of an elevator according to claim 6, wherein the light sources arranged with regularity on the ceiling of the cage are in the state that the light sources with different lighting colors are adjoined.

8. The lighting apparatus of an elevator according to claim 3, wherein the light sources are arranged with regularity on the ceiling of the cage.

9. The lighting apparatus of an elevator according to claim 8, wherein the light sources arranged with regularity on the ceiling of the cage are in the state that the light sources with different lighting colors are adjoined.
